(19) United States
(12) Patent Application Publication
(10) Pub. No.: US 2013/0004797 A1
(43) Pub. Date: Jan. 3, 2013

(54) MAGNETIC RECORDING MEDIUM

(75) Inventor: Shinji Uchida, Matsumoto-city (JP)

(73) Assignee: FUJI ELECTRIC CO., LTD., Kawasaki-shi (JP)

(21) Appl. No.: 13/488,690

(22) Filed: Jun. 5, 2012

(30) Foreign Application Priority Data
Jun. 29, 2011 (JP) 2011-144168

(51) Int. Cl. G11B 5/706

(52) U.S. Cl. 428/846

(57) ABSTRACT

A magnetic recording medium permits high recording densities while simultaneously satisfying requirements for the high-frequency SNR characteristic and the Squash characteristic. The magnetic recording medium includes at least a soft magnetic underlayer and a magnetic recording layer on a nonmagnetic substrate. The soft magnetic underlayer has a stacked structure that includes a soft magnetic layer on the nonmagnetic substrate side, an exchange coupling control layer, and a soft magnetic layer on the magnetic recording layer side. The soft magnetic layer on the magnetic recording layer side has a higher relative permeability characteristic frequency (the frequency at which the relative permeability is reduced by 50% compared with the relative permeability at 10 MHz) than the soft magnetic layer on the nonmagnetic substrate side, and the soft magnetic layer on the nonmagnetic substrate side has a higher relative permeability than the soft magnetic layer on the magnetic recording layer side.

### CROSS-REFERENCE TO RELATED APPLICATION

This application claims the benefit of priority of Japanese patent application number 2011-144168, filed on Jun. 29, 2011, the disclosure of which is incorporated herein by reference.

### BACKGROUND OF THE INVENTION

1. Field of the Invention

This invention relates to a magnetic recording medium used in a magnetic recording device.

2. Description of the Related Art

Increasingly, larger capacities and faster processing are being demanded of hard disk devices (HDDs), and magnetic recording media incorporated in HDDs must be capable of ever-higher recording densities. In the midst of such trends, perpendicular magnetic recording methods are being adopted as recording methods for magnetic recording media. Perpendicular magnetic recording methods are characterized by recording in the perpendicular direction of the recording media rather than in an in-plane direction. Media used in perpendicular magnetic recording methods must include, at least, a magnetic recording layer of a hard magnetic material having perpendicular magnetic anisotropy, and a soft magnetic underlayer (SUL) which serves to concentrate the magnetic flux generated by the single-pole head used for recording in the magnetic recording layer.

As shown in FIG. 3, a conventional representative perpendicular magnetic recording system comprises a magnetic recording medium 17 and a single-pole head 10. The single-pole head 10 comprises a main pole 11, a return yoke 12, and a coil 13 encompassing the return yoke. Magnetic flux 14 generated from the main pole 11 penetrates the magnetic recording layer 15 directly below the main pole and reaches the interior of the SUL 16. The magnetic flux spreads out in the SUL 16, penetrates the magnetic recording layer 15 directly below the return yoke 12, and returns to the return yoke 12. By this means, the region in the magnetic recording layer 15 directly below the main pole 11 is magnetized in a prescribed direction.

In general, the SUL in perpendicular magnetic recording media is formed from two soft magnetic layers, vertically separated by a film of Ru or a similar substance of thickness approximately 0.1 to 5 nm. The two vertically separated soft magnetic layers are antiferromagnetically coupled in antiparallel directions in the radial direction of the media face. This structure is called an antiferromagnetic coupling (AFC) structure. This AFC structure can reduce spike noise arising from domain walls in the SUL, and is also known to have an effect in suppressing WATE (Wide Adjacent Track Erasure).

In recent years there have been requests for still higher recording densities, but when recording and reproducing data at high densities, reduction of the signal-to-noise ratio (SNR) has been a problem. In general, the disk rotation rate of the magnetic recording media is constant regardless of the recording density, and in order to record at high densities, signals must be written with shorter periods. The above-described problem of reduced SNR arises from the fact that the magnetization response characteristic of the SUL can no longer keep up with the higher frequencies which accompany higher recording densities.

In addressing this problem, Japanese Patent Application Laid-open No. H5-282647 and Japanese Patent Application Laid-open No. 2000-268341 propose that a soft magnetic oxide of which ferrite is representative be used in the material of the soft magnetic layer constituting the SUL, and that losses caused by high-frequency recording magnetic fields due to eddy currents be reduced and magnetization responsiveness thereby be improved, to provide magnetic recording media with superior recording capability at high recording densities.

Further, although not an application directed to magnetic recording media, Japanese Patent Application Laid-open No. 2005-328046 discloses, as a material which achieves both satisfactory high-frequency characteristics and high saturation magnetization, a magnetic thin film which microscopically comprises a first amorphous phase including Fe and Co and responsible for the magnetic properties, and a second amorphous phase including boron (B) and carbon (C).

Soft magnetic oxides represented by the ferrites disclosed in Japanese Patent Application Laid-open No. H5-282647 and Japanese Patent Application Laid-open No. 2000-268341 have low saturation magnetization, and the film thickness necessary to cause the head magnetic flux to pass through is too great, so that without further modification such materials cannot easily be applied as the SUL. When using materials such as that disclosed in Japanese Patent Application Laid-open No. 2005-328046, as explained below, it has been discovered that in a conventional soft magnetic underlayer the SNR characteristic necessary at high frequencies is improved; but the inventors have discovered that at the same time, the oblique magnetization field resistance (Squash characteristic) is worsened.

### SUMMARY OF THE INVENTION

Hence an object of this invention is to provide magnetic recording media compatible with high recording densities which simultaneously satisfies demands relating to the high-frequency SNR characteristic and the Squash characteristic.

In order to attain the above-described object, this invention employs the following means.

A magnetic recording medium of this invention comprises at least a soft magnetic underlayer and a magnetic recording layer on a nonmagnetic substrate. The soft magnetic underlayer of this magnetic recording medium has a stacked structure comprising a soft magnetic layer on the nonmagnetic substrate side, an exchange coupling control layer, and a soft magnetic layer on the magnetic recording layer side, and moreover is characterized in that the soft magnetic layer on the magnetic recording layer side has a higher relative permeability characteristic frequency (the frequency at which the relative permeability is reduced by 50% compared with the relative permeability at 10 MHz) than the soft magnetic layer on the nonmagnetic substrate side, and the soft magnetic layer on the nonmagnetic substrate side has a higher relative permeability than the soft magnetic layer on the magnetic recording layer side.

In this invention, as a material responsible for magnetic properties in the soft magnetic underlayer, it is preferable that the soft magnetic layer on the nonmagnetic substrate side and the soft magnetic layer on the magnetic recording layer side include:

(i) a material including Fe and Co and responsible for the magnetic properties, and

(ii) an added material including an element selected from B, C, Ti, Zr, Hf, V, Nb or Ta, or a combination thereof.

In this invention, it is preferable that the characteristic frequency of the relative permeability of the soft magnetic layer on the magnetic recording layer side be 1000 MHz or higher, and that the relative permeability of the soft magnetic layer on the nonmagnetic substrate side or of the soft magnetic layer on the magnetic recording layer side be 700 or higher.

In a preferred embodiment of the invention, a magnetic recording medium including at least a soft magnetic underlayer and a magnetic recording layer on a nonmagnetic substrate is characterized in that the soft magnetic underlayer has a stacked structure comprising a soft magnetic layer on the nonmagnetic substrate side, an exchange coupling control layer, and a soft magnetic layer on the magnetic recording layer side; that the two soft magnetic layers are formed of a combination of soft magnetic layers including (i) a material including Fe and Co and responsible for the magnetic properties, and (ii) an added material including an element selected from B, C, Ti, Zr, Hf, V, Nb or Ta, or a combination thereof; and that a proportion of the magnetic material including Fe and Co in the soft magnetic layer on the nonmagnetic substrate side is greater than a proportion of the magnetic material including Fe and Co in the soft magnetic layer on the magnetic recording layer side.

The magnetic recording medium of the above-described preferred embodiment is characterized in that, in the soft magnetic underlayer, the proportion of the material including Fe and Co and responsible for the magnetic properties in the soft magnetic layer on the nonmagnetic substrate side is 82.5 vol % or above, and the proportion of the material including Fe and Co and responsible for the magnetic properties in the soft magnetic layer on the magnetic recording layer side is less than 82.5 vol %.

By means of this invention, a magnetic recording medium compatible with high recording densities, which simultaneously satisfies demands relating to the SNR characteristic necessary at high frequencies and the Squash characteristic, can be provided.

### BRIEF DESCRIPTION OF THE DRAWINGS

FIG. 1 shows the configuration of a perpendicular magnetic recording medium of an example;

FIG. 2 shows the detailed configuration of the SUL of a perpendicular magnetic recording medium of an example;

FIG. 3 shows the configuration of a general perpendicular magnetic recording system of the prior art; and

FIG. 4A to FIG. 4C show the results of measurements of the frequency dependence of relative permeability of examples of the invention.

### DESCRIPTION OF THE PREFERRED EMBODIMENTS

The inventors made magnetic recording media comprising, in the SUL (soft magnetic underlayer), soft magnetic layers in which a material including an element among B, C, Ti, Zr, Hf, V, Nb or Ta, or a combination thereof, was added as an added material to a material including Fe and Co which was responsible for the magnetic properties, and conducted diligent studies on the recording and reproduction characteristics. In these studies, magnetic recording media were also made with the SUL fabricated using soft magnetic layers comprising only Fe and Co for use as a reference in comparative studies. As a result, it was found that compared with the reference, SULs comprising soft magnetic layers to which the above-described added materials were added exhibited improvement in the SNR characteristic necessary at high frequencies as the proportion of the above-described added material was increased. However, at the same time it was found that the oblique magnetization resistance (Squash characteristic) was worsened.

The Squash characteristic is an index indicating the extent of write bleeding due to oblique magnetization. In greater detail, ideally the magnetic flux from the magnetic head is perpendicular with respect to the film plane of the magnetic recording layer. However, in actuality the magnetic flux spreads obliquely from the tip of the magnetic head to reach the SUL. Consequently, write bleeding in the crosstalk direction occurs due to this magnetic flux spreading. The Squash characteristic is an index indicating the extent of this write bleeding.

By increasing the proportion of the above-described added material, the characteristic frequency of the relative permeability of the soft magnetic layer improves. Hence the SNR characteristic necessary at high frequencies is thought to be improved. However, increasing the proportion of added material simultaneously caused an overall decline in the relative permeability of the soft magnetic layer. Consequently, it is thought, the ability of the SUL to draw in magnetic flux is reduced, the magnetic flux from the head spreads, and the Squash characteristic is worsened. In magnetic recording media using an SUL including a soft magnetic layer which comprises (i) a material including Fe and Co and responsible for the magnetic properties, and (ii) an added material including an element selected from B, C, Ti, Zr, Hf, V, Nb or Ta, or a combination thereof, as described above, there is a tradeoff between the high-frequency SNR and the Squash characteristic, and it was not possible to achieve the recording and reproduction characteristics necessary for magnetic recording media.

In light of the above-described results, the inventors conducted diligent research on magnetic recording media compatible with high recording densities which simultaneously satisfies requirements for the SNR characteristic necessary at high frequencies, and a satisfactory Squash characteristic. As a result, the magnetic recording medium of this invention was obtained.

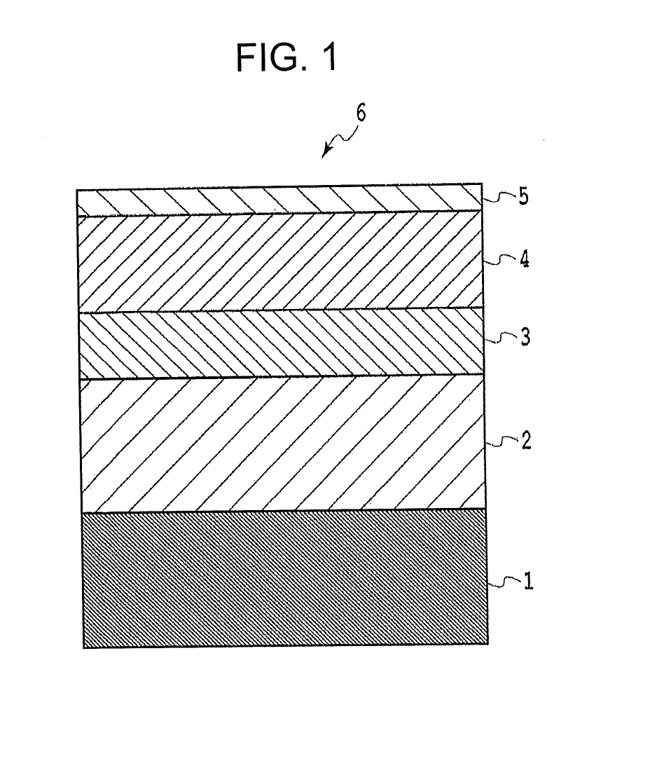

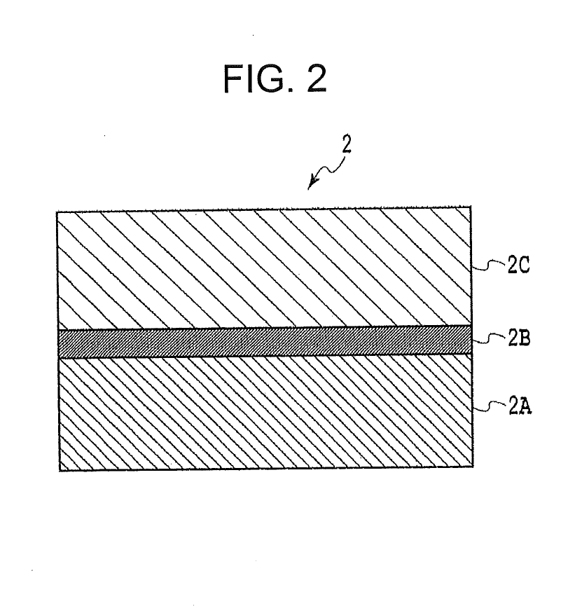

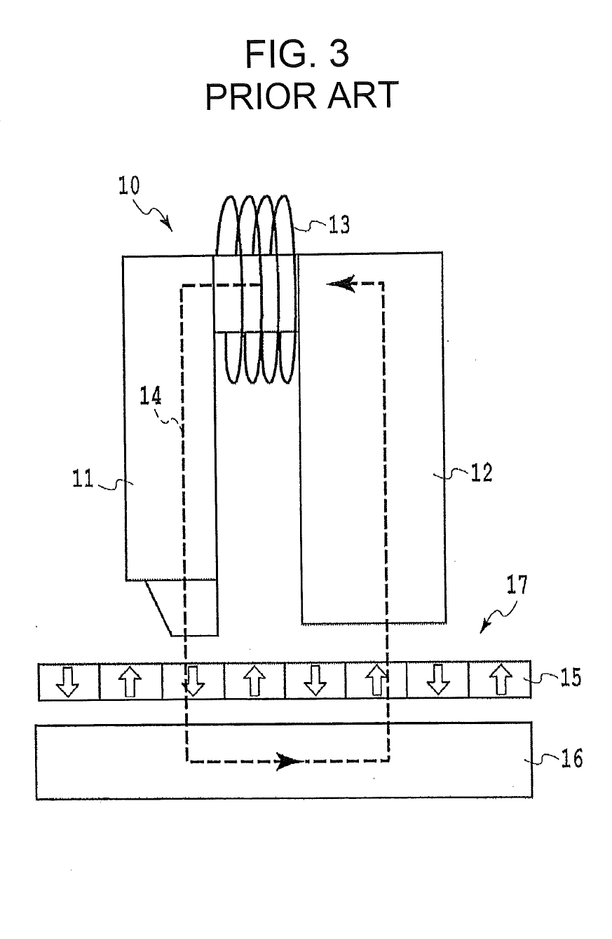

Below, an embodiment of a magnetic recording medium of the invention is explained based on FIG. 1 and FIG. 2. FIG. 1 shows an example of a magnetic recording medium 6 of the invention. FIG. 2 shows an example of the structure of an SUL of the invention.

The magnetic recording medium 6 of the invention comprises at least a nonmagnetic substrate 1, soft magnetic underlayer (SUL) 2, and magnetic recording layer 4. In this invention, as other optional layers, an underlayer 3, protective layer 5, and lubricating layer (not shown), and similar layers may be included. In this invention, it is preferable that the magnetic recording medium 6 have a structure in which a nonmagnetic substrate 1, SUL 2, underlayer 3, magnetic recording layer 4, protective layer 5, and lubricating layer are stacked in order.

The SUL 2 of the magnetic recording medium of this invention has a stacked structure comprising a soft magnetic layer 2A on the nonmagnetic substrate side (that is, closest to the substrate), an exchange coupling control layer 2B, and a soft magnetic layer 2C on the magnetic recording layer side (that is, closest to the magnetic recording layer), and is characterized in that the soft magnetic layer 2A on the nonmagnetic substrate side has a higher characteristic frequency of relative permeability than the soft magnetic layer 2C on the magnetic recording layer side.

In this Specification, “characteristic frequency of relative permeability” means the frequency at which the relative permeability of the soft magnetic layer declines by a constant amount compared to the relative permeability of the soft magnetic layer at a specific frequency. More specifically, the characteristic frequency of relative permeability is the frequency at which the relative permeability of the soft magnetic layer has declined by 50% compared to the relative permeability of the soft magnetic layer at 10 MHz.

As explained above, the SUL of the magnetic recording medium of this invention has a stacked structure comprising a soft magnetic layer on the nonmagnetic substrate side, an exchange coupling control layer, and a soft magnetic layer on the magnetic recording layer side, and is characterized in that the soft magnetic layer on the magnetic recording layer side has a higher characteristic frequency of relative permeability than the soft magnetic layer on the nonmagnetic substrate side. By improving the characteristic frequency of relative permeability of the soft magnetic layer on the magnetic recording layer side, the SNR characteristic held to be necessary at high frequencies can be improved. This is because high-frequency magnetic flux can easily pass through comparatively shallow portions of the SUL (portions near the magnetic recording layer).

Further, the characteristic frequency of relative permeability of the soft magnetic layer on the nonmagnetic substrate side is low compared with that of the soft magnetic layer on the magnetic recording layer side, but to this extent the relative permeability of the soft magnetic layer on the nonmagnetic substrate side is high. Where the Squash characteristic is concerned, it is effective to raise the relative permeability of the SUL as a whole. To this end, by making the relative permeability of the soft magnetic layer on the nonmagnetic substrate side higher than that of the soft magnetic layer on the magnetic recording layer side, the relative permeability of the SUL as a whole can be raised, and it is thought that as a consequence the Squash characteristic can be improved.

As explained above, in this invention the SUL 2 has a stacked structure comprising a soft magnetic layer 2A on the nonmagnetic substrate side, an exchange coupling control layer 2B, and a soft magnetic layer 2C on the magnetic recording layer side, and the relations between the characteristic frequency of relative permeability and the relative permeability (at 100 MHz) of the soft magnetic layer 2A on the nonmagnetic substrate side and the soft magnetic layer 2C on the magnetic recording layer side are set as described above. By this means, a magnetic recording medium can be provided with improvements in both the Squash characteristic and the SNR characteristic. Further, the above-described considerations also apply to an SUL prepared using materials normally employed in perpendicular magnetic recording media, with materials responsible for magnetic properties other than FeCo. Hence it should be clear to a person skilled in the art that this invention can be applied to materials among Fe-based transition metal alloys in the same series as FeCo, which preferably include Fe, Co, Ni, Cr and similar elements, and are responsible for the magnetic properties.

Next, materials of the magnetic recording medium of the invention will be explained.

As the nonmagnetic substrate 1, NiP-plated Al alloy or glass, or crystallized glass, normally used in magnetic recording media, or an Si substrate, can be employed.

The soft magnetic underlayer (SUL) 2 is a layer provided to control the magnetic flux from the magnetic head and improve the recording and reproduction characteristics, similarly to current perpendicular recording systems. The optimum value for the entire film thickness of the soft magnetic underlayer 2 varies depending on the structure and characteristics of the magnetic head used in magnetic recording; but when formed as a film continuously with other layers, from considerations of productivity it is desirable that the thickness be 10 nm or greater and 100 nm or less.

In this invention, the SUL 2 has a soft magnetic layer 2A on the nonmagnetic substrate side and a soft magnetic layer 2C on the magnetic recording layer side as shown in FIG. 2, and these two layers are magnetically coupled in antiparallel directions within the plane of the medium with the exchange coupling control layer 2B intervening. By this means, the two soft magnetic layers 2A and 2C constitute an AFC-SUL structure.

In the SUL 2 of the magnetic recording medium of the invention, it is preferable that the materials of the soft magnetic layer 2A on the nonmagnetic substrate side and soft magnetic layer 2C on the magnetic recording layer side be materials which combine a material responsible for the magnetic properties, and an added material including an element among B, C, Ti, Zr, Hf, V, Nb or Ta, or a combination of these. As a material responsible for the magnetic properties, an Fe-based transition metal alloy or similar substance can be used. In particular, in this invention it is preferable that a material including Fe, Co, Ni, Cr or similar substance and responsible for the magnetic properties be used, and it is particularly preferable that a material including Fe and Co and responsible for the magnetic properties be used. It is preferable that the soft magnetic material 2C on the magnetic recording layer side have a higher proportion of the above-described added material than the soft magnetic layer 2A on the nonmagnetic substrate side. By this means, the soft magnetic layer 2C on the magnetic recording layer side has a relative permeability which is lower than that of the soft magnetic layer 2A on the nonmagnetic substrate side, but the characteristic frequency of the relative permeability is improved. Conversely, the soft magnetic layer 2A on the nonmagnetic substrate side has a characteristic frequency of relative permeability which is lower than that of the soft magnetic layer 2C on the magnetic recording layer side, but the relative permeability is still high. By employing the above-described structure for the SUL 2, a magnetic recording medium compatible with high recording densities can be provided which simultaneously satisfies requirements for both the SNR characteristic necessary at high frequencies and the Squash characteristic.

The film thicknesses of the soft magnetic layer 2A on the nonmagnetic substrate side and the soft magnetic layer 2C on the magnetic recording layer side may be equal, or may be different, according to considerations of the recording and reproduction characteristics. For example, a film thickness for the soft magnetic layer 2A on the nonmagnetic substrate side of 5 to 50 nm is preferable, and a film thickness for the soft magnetic layer 2C on the magnetic recording layer side of 5 to 50 nm is preferable. Further, each of the soft magnetic layers may be formed by stacking a plurality of layers in which the composition is changed in steps. For example, a stacked structure in which the composition ratios of B, Ta or similar are changed is preferable.

The soft magnetic layer 2C on the magnetic recording layer side has a higher characteristic frequency of relative permeability than the soft magnetic layer 2A on the nonmagnetic substrate side. As explained above, the “characteristic frequency of relative permeability” is the frequency at which the relative permeability of the soft magnetic layer declines by a constant amount compared to the relative permeability of the soft magnetic layer at a specific frequency, and more specifically, the frequency at which the relative permeability has declined by 50% compared to the relative permeability of the soft magnetic layer at 10 MHz. In this invention, it is preferable that this frequency be 1000 MHz or higher. For example, as a material with such a characteristic, it is preferable that the material responsible for the magnetic properties (FeCo) be less than 82.5 vol %. For example, materials described in the example in which the material responsible for the magnetic properties is at the above-described content can be cited; one such example is material comprising 80 vol % (Fe₇₀Co₃₀), 15 vol % Ta, and 5 vol % B.

Further, in this invention the soft magnetic layer 2A on the nonmagnetic substrate side has a higher relative permeability at frequencies of 100 MHz or lower than the soft magnetic layer 2C on the magnetic recording layer side. In this invention, it is preferable that the relative permeability of at least the soft magnetic layer 2A on the nonmagnetic substrate side be 700 or higher. In this invention, one condition is that the soft magnetic layer 2A on the nonmagnetic substrate side have a higher relative permeability at 100 MHz or lower than the soft magnetic layer 2C on the magnetic recording layer side, and therefore if one among the soft magnetic layer 2A on the nonmagnetic substrate side and the soft magnetic layer 2C on the magnetic recording layer side has a relative permeability of 700 or higher, then this condition for the soft magnetic layer 2A on the nonmagnetic substrate side is satisfied. As material exhibiting such a characteristic, it is preferable that the (FeCo) material responsible for the magnetic properties account for 82.5 vol % or more. For example, materials described in the example in which the material responsible for the magnetic properties is at the above-described content can be cited; one such example is material comprising 85 vol % (Fe₇₀Co₃₀), 12 vol % Ta, and 3 vol % B.

It is preferable that the material of the exchange coupling control layer 2B be material which does not readily diffuse into the material of the nonmagnetic substrate 1 or the materials of the soft magnetic layers 2A and 2C. Examples of such materials include Pt, Pd, Ru and similar; in particular, Ru is preferable. The film thickness of the exchange coupling control layer 2B need only be a thickness such that there is appropriate antiferromagnetic coupling between the soft magnetic layer 2A on the nonmagnetic substrate side and the soft magnetic layer 2C on the magnetic recording layer side; for example, a thickness of approximately 0.1 to 5 nm is preferable.

Next, the underlayer 3, which is an optional component, is a layer provided for (1) control of the crystal grain diameter and crystal orientation of the magnetic recording layer 4, and (2) prevention of magnetic coupling between the soft magnetic underlayer (SUL) 2 and the magnetic recording layer 4. Hence the material of the underlayer 3 must be selected appropriately according to the material of the magnetic recording layer. For example, when the material of the magnetic recording layer 4 positioned directly above the underlayer 3 is a material the principal component of which is Co having the hexagonal close packed (hcp) structure, it is preferable that the material of the underlayer 3 be selected from among materials having the same hexagonal close packed structure or the face centered cubic (fcc) structure. Specifically, Ru, Re, Rh, Pt, Pd, Ir, Ni, Co, or an alloy containing these, can be cited as examples of materials of the underlayer 3. The thinner the underlayer 3, the more the write performance is improved. However, considering the above-described functions (1) and (2), a certain film thickness for the underlayer 3 is required. In this invention, it is preferable that the film thickness be in the range 3 to 30 nm.

It is preferable that the material of the magnetic recording layer 4 be a crystalline magnetic material. As the material of the magnetic recording layer 4, preferred ferromagnetic materials which are alloys including Co and Pt can be cited. The easy axis of magnetization of the ferromagnetic material must be oriented in the direction in which magnetic recording is performed. For example, when performing perpendicular magnetic recording, the easy axis of magnetization (for example, the c axis in the hcp structure) of the material of the magnetic recording layer 4 must be oriented in the direction perpendicular to the surface of the magnetic recording medium (that is, the principal plane of the nonmagnetic substrate).

Or, the magnetic recording layer 4 preferably has a structure in which magnetic crystal grains are separated by nonmagnetic material. In this case, it is preferable that magnetic crystal grains have a composition the principal component of which is Co, Fe, Ni, or another magnetic element, and that the shape be columnar with a diameter of several nanometers. Specifically, it is preferable that magnetic crystal grains be a material comprising a CoPt alloy, to which is added Cr, B, Ta, W, or another metal. It is preferable that the nonmagnetic material have a thickness of approximately less than a nanometer. It is preferable that the nonmagnetic material be an oxide or a nitride of Si, Cr, Co, Ti, or Ta.

A conventional method can be used as the method of fabrication of the magnetic recording layer 4. For example, the magnetron sputtering method can be used.

In this invention, it is preferable that crystal growth be induced such that there is a correspondence relation in which magnetic crystal grains are epitaxially grown on the crystalline portions of the underlayer 3, and the nonmagnetic material is positioned above the grain boundaries of the underlayer 3.

The film thickness of the magnetic recording layer 4 is similar to that of the prior art, and preferably is from 5 to 20 nm.

The protective layer 5 can use material used in the prior art. For example, material the principal component of which is carbon can be cited. Specifically, it is preferable that carbon, a nitride-containing carbon material, a hydrogen-containing carbon material, or similar be used. Rather than a single layer, for example a carbon protective layer comprising two layers with different properties, or a protective layer comprising a stacked-layer film of a metal film and a carbon film or an oxide film and a carbon film, can be used. It is preferable that the representative thickness of the protective layer be 10 nm or less.

Although not shown in the figures, a lubricating layer may be formed above the protective layer 5. When the head slides over the medium, the lubricating layer, intervening between the two, serves to prevent wear to the medium surface. As such a material, a fluorine-based liquid lubricant is appropriate. For example, organic compounds such as HO—CH₂—CF₂—(CF₂—O)ₘ—(C₂F₄—O)ₙ—CF₂—CH₂—OH (where n+m is approximately 40) can be used. It is preferable that the film thickness of the liquid lubricating layer be a thickness enabling manifestation of the function of the liquid lubricating layer, taking into account the film thickness of the protective layer and similar.

Each of the layers stacked on the nonmagnetic substrate 1 can be formed by various film deposition techniques normally used in the field of magnetic recording media. While a portion of these techniques were described above, each of the layers except for the liquid lubricating layer can be formed by for example a DC magnetron sputtering method or a vacuum evaporation deposition method. To form the liquid lubricating layer, for example a dipping method or a spin-coating method can be used.

### EXAMPLES

Below, the perpendicular magnetic recording medium of this invention is explained more specifically based on examples. These examples are merely representative examples used to explain the perpendicular magnetic recording medium of the invention, and the invention is not limited to these examples.

Using FIG. 1 and FIG. 2, a magnetic recording medium and methods of manufacture thereof are explained in detail below, referring to examples and comparative examples.

### Example 1

In Example 1, as shown in FIG. 1, a FeCo based SUL 2, underlayer 3 comprising Ru, CoCrPt—SiO₂ granular magnetic recording layer 4, protective layer 5 comprising carbon (C), and liquid lubricating layer, not shown, were formed in order on a nonmagnetic substrate 1, to manufacture a perpendicular magnetic recording medium 6. As the liquid lubricating layer, A-20H manufactured by Moresco Corp., the principal component of which is perfluoro polyether, was used. The specific procedures for manufacture were as follows.

As the nonmagnetic substrate 1, a disc-shaped chemically reinforced substrate with a smooth surface (N-10 glass substrate manufactured by Hoya Corp.) was used.

First, the nonmagnetic substrate 1 was placed within a film deposition apparatus. Films from the SUL 2 to the protective layer 5 were deposited using the film deposition apparatus in a completely inline process, without breaking the vacuum.

The SUL 2 in FIG. 1 was fabricated so as to have the SUL structure of FIG. 2 (2A, 2B and 2C). First, in an Ar gas atmosphere at pressure 1.0 Pa, the DC magnetron sputtering method was used to fabricate the soft magnetic layer 2A on the nonmagnetic substrate side, comprising 85 vol % (Fe₇₀Co₃₀), 12 vol % Ta, and 3 vol % B, with a film thickness of 18 nm. Next, in an Ar gas atmosphere at pressure 0.5 Pa, the DC magnetron sputtering method was used to form the exchange coupling control layer 2B, comprising Ru, with a film thickness of 0.5 nm. Next, in an Ar gas atmosphere at pressure 1.0 Pa, the DC magnetron sputtering method was used to fabricate the soft magnetic layer 2C on the magnetic recording layer side, comprising 80 vol % (Fe₇₀Co₃₀), 15 vol % Ta, and 5 vol % B, with a film thickness of 22 nm.

Next, as the underlayer 3, the DC magnetron sputtering method was used in an Ar gas atmosphere at pressure 1.5 Pa to form a layer 20 nm thick comprising Ru.

Next, as the magnetic recording layer 4, the DC magnetron sputtering method was used in an Ar gas atmosphere at pressure 1.0 Pa to form a layer 15 nm thick having the composition 91 vol % (Co₇₅Cr₁₅Pt₁₀) and 9 vol % (SiO₂).

Next, as the protective layer 5, a CVD method was used to form a carbon layer of film thickness 3 nm. Thereupon the substrate 1 with the above-described layers formed was removed from the inline-type film deposition apparatus.

Finally, a liquid lubricating layer comprising perfluoro polyether was formed to a film thickness of 2 nm by a dipping method, to obtain the magnetic recording medium 6.

### Example 2

Next, magnetic recording media of Examples 2-1 to 2-19 were fabricated, with the volume proportions of the Fe₇₀Co₃₀ which is the material responsible for the magnetic properties and the Ta and B of the added material varied in both the soft magnetic layer 2A on the nonmagnetic substrate side and the soft magnetic layer 2C on the magnetic recording layer side. The magnetic recording media were manufactured such that the compositions of the soft magnetic layers were (100-x-y) vol % (Fe₇₀Co₃₀), x vol % Ta, and y vol % B. The total of the film thicknesses of the soft magnetic layer 2A on the nonmagnetic substrate side and the soft magnetic layer 2C on the magnetic recording layer side was 40 nm, and the film thicknesses of the soft magnetic layer 2A on the nonmagnetic substrate side and the soft magnetic layer 2C on the magnetic recording layer side were modified appropriately such that the product of the film thickness and the saturation magnetization (Bs) was the same for both layers. Table 1 shows the compositions of the soft magnetic layer 2A on the nonmagnetic substrate side and the soft magnetic layer 2C on the magnetic recording layer side of the manufactured samples.

Other than the above, conditions were the same as in Example 1.

### Example 3

As samples for use in evaluating relative permeability and the characteristic frequency thereof, samples were manufactured by forming, on disc-shaped chemically reinforced substrates with a smooth surface (N-10 glass substrate manufactured by Hoya Corp.), a (Fe₇₀CO₃₀)_{100-x-y}TaₓB_{y} soft magnetic layer of film thickness 40 nm, and a carbon layer with a film thickness of 3 nm as a protective layer. Sample manufacture employed the same inline-type film deposition apparatus as in Example 1. The soft magnetic layer was formed by the DC magnetron sputtering method in an Ar gas atmosphere at pressure 1.0 Pa, and the carbon layer was formed by the CVD method.

The manufactured samples are described in Table 2.

### Example 4

Next, samples (magnetic recording media) were manufactured using Fe₇₀Co₃₀ as the material responsible for the magnetic properties in the soft magnetic layer 2A on the nonmagnetic substrate side and the soft magnetic layer 2C on the magnetic recording layer side, combined with added material appropriately selected from B, C, Ti, Zr, Hf, V, Nb or Ta. The total of the film thicknesses of the soft magnetic layer 2A on the nonmagnetic substrate side and the soft magnetic layer 2C on the magnetic recording layer side was 40 nm, the film thicknesses of the soft magnetic layer 2A on the nonmagnetic substrate side and the soft magnetic layer 2C on the magnetic recording layer side were modified appropriately such that the product of the film thickness and the saturation magnetization (Bs) was the same for both layers.

Other than the above, conditions were the same as in Example 1. The manufactured samples are described in Table 3.

Evaluations

First, results of evaluation of the performance of the magnetic recording media manufactured in Examples 1, 2 and 4 are described. Table 1 shows for the samples fabricated in Examples 1 and 2, and Table 3 shows for the samples manufactured in Example 4, the results of evaluations of the SNR characteristics and Squash characteristics.

Measurement of the SNR characteristics and Squash characteristics were performed using a spin-stand tester with a commercially marketed GMR head. The head used had a recording track width of 100 nm and a reproduction track width of 75 nm.

The SNR characteristic was determined from the proportion of the signal output to the noise output when a signal was written at a recording frequency of 250 MHz. Cases in which the SNR was 10 dB or higher were deemed superior (indicated by a circle symbol O), and cases in which the SNR was 9 dB or higher but less than 10 dB were deemed fair (indicated by a triangle symbol Δ). Unsatisfactory cases are indicated by an x symbol.

The Squash characteristic is the value, for a signal recorded at frequency 70 MHz, of the signal output after writing an AC erase signal 50 times on the adjacent tracks on both sides, normalized by (compared with) the initial signal output. Squash values of 60% or higher were deemed superior (O), while values of 50% or higher and less than 60% were deemed fair (Δ). Unsatisfactory values are indicated by an × symbol.

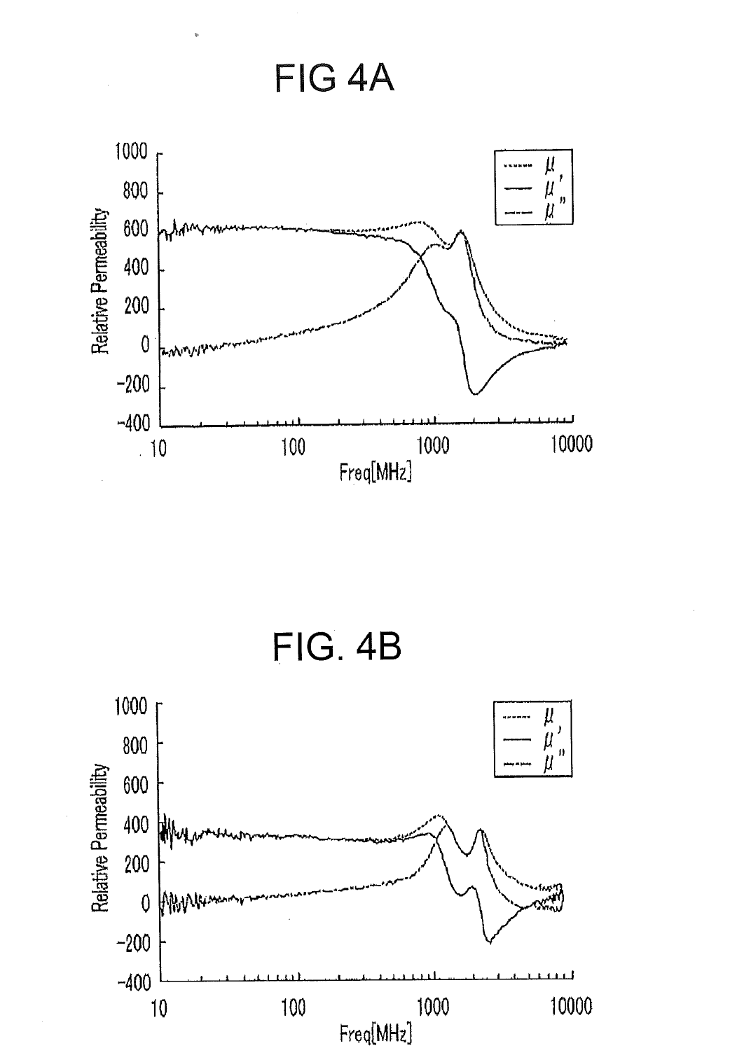

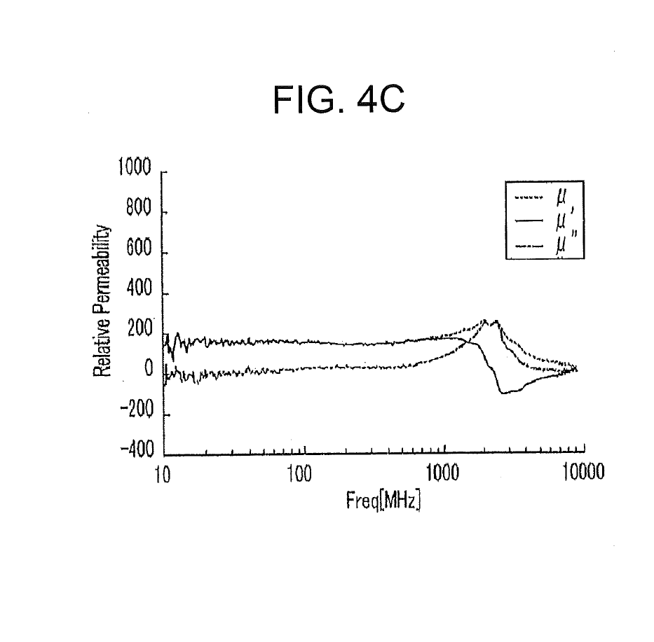

Next, the relative permeability and the characteristic frequency of relative permeability of the samples manufactured in Example 3 are described. FIG. 4A to FIG. 4C show examples of measurements of the relative permeability and the frequency dependence of relative permeability. Table 2 summarizes results for the relative permeability and the characteristic frequency of relative permeability of the samples manufactured in Example 3. Table 4 summarizes results of measurements of the relative permeability and the characteristic frequency of relative permeability of the soft magnetic layer 2A on the nonmagnetic substrate side and the soft magnetic layer 2C on the magnetic recording layer side of the samples for evaluation manufactured in Example 4, fabricating using the same procedure as in Example 3.

The relative permeability and characteristic frequency of relative permeability were measured using a PMM-9G1 apparatus manufactured by Ryowa Electronics Co., Ltd., over the range from 1 MHz to 9 GHz. The relative permeability μ can be measured by resolving into the real part μ′ and the imaginary part μ″.

Values of the relative permeability and the characteristic frequency of relative permeability appearing in Table 2 and Table 3 are for the real part μ′. The relative permeability was taken to be the relative permeability at frequency 10 MHz; the characteristic frequency of relative permeability shown is the frequency at which the relative permeability is half (declined by 50%) the value at frequency 10 MHz.

FIG. 4 presents as graphs the results for soft magnetic layers with the following compositions among those in Table 2. FIG. 4A shows measured results for the soft magnetic layer having the composition 82 vol % (Fe₇₀Co₃₀), 14 vol % Ta, 4 vol % B; FIG. 4B shows measured results for the soft magnetic layer having the composition 81 vol % (Fe₇₀Co₃₀), 14 vol % Ta, 5 vol % B; and FIG. 4C shows measured results for the soft magnetic layer having the composition 80 vol % (Fe₇₀Co₃₀), 15 vol % Ta, 5 vol % B.

TABLE 1

| | Soft magnetic layer on | Soft magnetic layer on | | |
|---|---|---|---|---|
| Example | nonmagnetic substrate side | magnetic recording layer side | Squash | SNR |
| 1 | 85 vol % (Fe₇₀Co₃₀), 12 | 80 vol % (Fe₇₀Co₃₀), 15 | ∘ | ∘ |
| | vol % Ta, 3 vol % B | vol % Ta, 5 vol % B | | |
| 2-1 | 83 vol % (Fe₇₀Co₃₀), 13 | 82 vol % (Fe₇₀Co₃₀), 14 | ∘ | ∘ |
| | vol % Ta, 4 vol % B | vol % Ta, 4 vol % B | | |
| 2-2 | 82.5 vol % (Fe₇₀Co₃₀), 13.5 | 82.5 vol % (Fe₇₀Co₃₀), 13.5 | ∘ | Δ |
| | vol % Ta, 4 vol % B | vol % Ta, 4 vol % B | | |
| 2-3 | 82 vol % (Fe₇₀Co₃₀), 14 | 83 vol % (Fe₇₀Co₃₀), 13 | ∘ | x |
| | vol % Ta, 4 vol % B | vol % Ta, 4 vol % B | | |
| 2-4 | 83 vol % (Fe₇₀Co₃₀), 13 | 80 vol % (Fe₇₀Co₃₀), 15 | ∘ | ∘ |
| | vol % Ta, 4 vol % B | vol % Ta, 5 vol % B | | |
| 2-5 | 81 vol % (Fe₇₀Co₃₀), 14 | 80 vol % (Fe₇₀Co₃₀), 15 | Δ | ∘ |
| | vol % Ta, 5 vol % B | vol % Ta, 5 vol % B | | |
| 2-6 | 80 vol % (Fe₇₀Co₃₀), 15 | 80 vol % (Fe₇₀Co₃₀), 15 | x | ∘ |
| | vol % Ta, 5 vol % B | vol % Ta, 5 vol % B | | |
| 2-7 | 78 vol % (Fe₇₀Co₃₀), 16 | 80 vol % (Fe₇₀Co₃₀), 15 | x | ∘ |
| | vol % Ta, 6 vol % B | vol % Ta, 5 vol % B | | |
| 2-8 | 82 vol % (Fe₇₀Co₃₀), 14 | 85 vol % (Fe₇₀Co₃₀), 12 | ∘ | x |
| | vol % Ta, 4 vol % B | vol % Ta, 3 vol % B | | |
| 2-9 | 84 vol % (Fe₇₀Co₃₀), 13 | 85 vol % (Fe₇₀Co₃₀), 12 | ∘ | x |
| | vol % Ta, 3 vol % B | vol % Ta, 3 vol % B | | |
| 2-10 | 85 vol % (Fe₇₀Co₃₀), 12 | 85 vol % (Fe₇₀Co₃₀), 12 | ∘ | x |
| | vol % Ta, 3 vol % B | vol % Ta, 3 vol % B | | |
| 2-11 | 87 vol % (Fe₇₀Co₃₀), 10 | 85 vol % (Fe₇₀Co₃₀), 12 | ∘ | x |
| | vol % Ta, 3 vol % B | vol % Ta, 3 vol % B | | |
| 2-12 | 85 vol % (Fe₇₀Co₃₀), 12 | 82 vol % (Fe₇₀Co₃₀), 14 | ∘ | ∘ |
| | vol % Ta, 3 vol % B | vol % Ta, 4 vol % B | | |
| 2-13 | 85 vol % (Fe₇₀Co₃₀), 12 | 84 vol % (Fe₇₀Co₃₀), 13 | ∘ | Δ |
| | vol % Ta, 3 vol % B | vol % Ta, 3 vol % B | | |
| 2-14 | 85 vol % (Fe₇₀Co₃₀), 12 | 85 vol % (Fe₇₀Co₃₀), 12 | ∘ | Δ |
| | vol % Ta, 3 vol % B | vol % Ta, 3 vol % B | | |
| 2-15 | 85 vol % (Fe₇₀Co₃₀), 12 | 87 vol % (Fe₇₀Co₃₀), 10 | ∘ | x |
| | vol % Ta, 3 vol % B | vol % Ta, 3 vol % B | | |
| 2-16 | 80 vol % (Fe₇₀Co₃₀), 15 | 85 vol % (Fe₇₀Co₃₀), 12 | ∘ | x |
| | vol % Ta, 5 vol % B | vol % Ta, 3 vol % B | | |
| 2-17 | 80 vol % (Fe₇₀Co₃₀), 15 | 83 vol % (Fe₇₀Co₃₀), 13 | ∘ | x |
| | vol % Ta, 5 vol % B | vol % Ta, 4 vol % B | | |
| 2-18 | 80 vol % (Fe₇₀Co₃₀), 15 | 81 vol % (Fe₇₀Co₃₀), 14 | Δ | ∘ |
| | vol % Ta, 5 vol % B | vol % Ta, 5 vol % B | | |
| 2-19 | 80 vol % (Fe₇₀Co₃₀), 15 | 80 vol % (Fe₇₀Co₃₀), 15 | x | ∘ |
| | vol % Ta, 5 vol % B | vol % Ta, 5 vol % B | | |

TABLE 2

| | | Characteristic |
|---|---|---|
| | Relative | frequency |
| | permeability | of relative |
| Composition of soft magnetic layer | at 10 MHz | permeability^{a)} |
| 87 vol % (Fe₇₀Co₃₀), 10 vol % Ta, 3 | 1600 | 25 MHz |
| vol % B | | |
| 85 vol % (Fe₇₀Co₃₀), 12 vol % Ta, 3 | 1200 | 100 MHz |
| vol % B | | |
| 84 vol % (Fe₇₀Co₃₀), 13 vol % Ta, 3 | 1050 | 300 MHz |
| vol % B | | |
| 83 vol % (Fe₇₀Co₃₀), 13 vol % Ta, 4 | 900 | 600 MHz |
| vol % B | | |
| 82.5 vol % (Fe₇₀Co₃₀), 13.5 vol % Ta, 4 | 700 | 800 MHz |
| vol % B | | |
| 82 vol % (Fe₇₀Co₃₀), 14 vol % Ta, 4 | 600 | 1000 MHz |
| vol % B | | |
| 81 vol % (Fe₇₀Co₃₀), 14 vol % Ta, 5 | 350 | 1200 MHz |
| vol % B | | |
| 80 vol % (Fe₇₀Co₃₀), 15 vol % Ta, 5 | 150 | 2000 MHz |
| vol % B | | |
| 78 vol % (Fe₇₀Co₃₀), 16 vol % Ta, 6 | 100 | 3000 MHz |
| vol % B | | |

^{a)}Frequency at which the relative permeability has declined by 50%, compared with the relative permeability at 10 MHz

TABLE 3

| | Soft magnetic layer on | Soft magnetic layer on | | |
|---|---|---|---|---|
| Example | nonmagnetic substrate side | magnetic recording layer side | Squash | SNR |
| 4-1 | 85 vol % (Fe₇₀Co₃₀), 4 vol % | 80 vol % (Fe₇₀Co₃₀), 5 vol % | ∘ | ∘ |
| | Zr, 4 vol % Ta, 7 vol % Nb | Zr, 5 vol % Ta, 10 vol % Nb | | |
| 4-2 | 83 vol % (Fe₇₀Co₃₀), 12 vol % | 81 vol % (Fe₇₀Co₃₀), 5 vol % | ∘ | ∘ |
| | Ta, 5 vol % C | Zr, 5 vol % Ta, 9 vol % Nb | | |
| 4-3 | 84 vol % (Fe₇₀Co₃₀), 4 vol % | 82 vol % (Fe₇₀Co₃₀), 5 vol % | ∘ | ∘ |
| | Zr, 4 vol % Ta, 8 vol % Ti | Zr, 5 vol % Ta, 8 vol % V | | |
| 4-4 | 85 vol % (Fe₇₀Co₃₀), 15 vol % | 78 vol % (Fe₇₀Co₃₀), 16 vol % | ∘ | ∘ |
| | Ta | Ta, 6 vol % B | | |
| 4-5 | 83 vol % (Fe₇₀Co₃₀), 5 vol % | 80 vol % (Fe₇₀Co₃₀), 5 vol % | ∘ | ∘ |
| | Zr, 5 vol % Ta, 7 vol % Ti | Zr, 5 vol % Ta, 10 vol % Ti | | |

TABLE 4

| | | Characteristic |
|---|---|---|
| | Relative | frequency |
| Composition of soft | permeability | of relative |
| magnetic layer | at 10 MHz | permeability^{a)} |
| 85 vol % (Fe₇₀Co₃₀), 4 | 1180 | 100 MHz |
| vol % Zr, 4 vol % Ta, 7 | | |
| vol % Nb | | |
| 83 vol % (Fe₇₀Co₃₀), 12 | 870 | 580 MHz |
| vol % Ta, 5 vol % C | | |
| 84 vol % (Fe₇₀Co₃₀), 4 | 1000 | 310 MHz |
| vol % Zr, 4 vol % Ta, 8 | | |
| vol % Ti | | |
| 85 vol % (Fe₇₀Co₃₀), 15 | 1150 | 120 MHz |
| vol % Ta | | |
| 83 vol % (Fe₇₀Co₃₀), 5 | 850 | 620 MHz |
| vol % Zr, 5 vol % Ta, 7 vol % Ti | | |
| 80 vol % (Fe₇₀Co₃₀), 5 | 140 | 2200 MHz |
| vol % Zr, 5 vol % Ta, 10 | | |
| vol % Nb | | |
| 81 vol % (Fe₇₀Co₃₀), 5 | 340 | 1200 MHz |
| vol % Zr, 5 vol % Ta, 9 | | |
| vol % Nb | | |
| 82 vol % (Fe₇₀Co₃₀), 5 | 580 | 1000 MHz |
| vol % Zr, 5 vol % Ta, 8 | | |
| vol % V | | |
| 78 vol % (Fe₇₀Co₃₀), 16 | 80 | 2800 MHz |
| vol % Ta, 6 vol % B | | |
| 80 vol % (Fe₇₀Co₃₀), 5 | 160 | 1900 MHz |
| vol % Zr, 5 vol % Ta, 10 | | |
| vol % Ti | | |

^{a)}Frequency at which the relative permeability has declined by 50%, compared with the relative permeability at 10 MHz

The results of the above tables can be summarized as follows. First, the results of Table 1 are considered.

From comparisons of Example 1 and Examples 2-1 to 2-3 in Table 1, when the material containing Fe and Co responsible for the magnetic properties is combined with an added material of B and Ta in the soft magnetic layers, if the proportion of the material responsible for the magnetic properties (FeCo) in the soft magnetic layer 2A on the nonmagnetic substrate side is greater than the proportion of the material responsible for the magnetic properties (FeCo) in the soft magnetic layer 2C on the magnetic recording layer side, a magnetic recording medium could be obtained which satisfies the SNR requirement while maintaining the Squash characteristic.

In Examples 2-4 to 2-7, the composition of the soft magnetic layer 2C on the magnetic recording layer side was fixed at 80 vol % (Fe₇₀Co₃₀), 15 vol % Ta, 5 vol % B, and the proportion of the material (Fe₇₀Co₃₀) responsible for the magnetic properties in the soft magnetic layer 2A on the nonmagnetic substrate side was varied from 83 vol % to 78 vol %. The SNR for all the media of Examples 2-4 to 2-7 was maintained in the superior (O) range, but when the proportion of the material (Fe₇₀Co₃₀) responsible for the magnetic properties in the soft magnetic layer 2A on the nonmagnetic substrate side was reduced below 81 vol %, the Squash characteristic deviated from the superior (O) range.

In Examples 2-8 to 2-11, the composition of the soft magnetic layer 2C on the magnetic recording layer side was fixed at 85 vol % (Fe₇₀Co₃₀), 12 vol % Ta, 3 vol % B, and the proportion of the material (Fe₇₀Co₃₀) responsible for the magnetic properties in the soft magnetic layer 2A on the nonmagnetic substrate side was varied from 82 vol % to 87 vol %. As a result, the Squash characteristic was superior (O) for all samples, but the SNR deviates from the superior (O) range.

In Examples 2-12 to 2-15, the composition of the soft magnetic layer 2A on the nonmagnetic substrate side was fixed at 85 vol % (Fe₇₀Co₃₀), 12 vol % Ta, 3 vol % B, and the proportion of the material (Fe₇₀Co₃₀) responsible for the magnetic properties in the soft magnetic layer 2C on the magnetic recording layer side was varied from 82 vol % to 87 vol %. At this time the Squash characteristic was superior (O) for all the examples (Examples 2-12 to 2-15), but when the proportion of the material (Fe₇₀Co₃₀) responsible for the magnetic properties in the soft magnetic layer 2C on the magnetic recording layer side became greater than 84 vol %, the SNR characteristic deviated from the superior (O) range.

In Examples 2-16 to 2-19, the composition of the soft magnetic layer 2A on the nonmagnetic substrate side was fixed at 80 vol % (Fe₇₀Co₃₀), 15 vol % Ta, 5 vol % B, and the proportion of the material (Fe₇₀Co₃₀) responsible for the magnetic properties in the soft magnetic layer 2C on the magnetic recording layer side was varied from 85 vol % to 80 vol %. In the case of these examples, for proportions of the (Fe₇₀Co₃₀) material responsible for the magnetic properties in the soft magnetic layer 2C on the magnetic recording layer side of 83 vol % or higher, the Squash characteristic was superior (O), but the SNR characteristic deviated from superior (O) (Examples 2-16 and 2-17). Further, for proportions of the (Fe₇₀Co₃₀) material responsible for the magnetic properties in the soft magnetic layer 2C on the magnetic recording layer side of 81 vol % or lower, the SNR characteristic was superior (O), but the Squash characteristic deviated from superior (O). Hence in these examples which used FeCo as the material responsible for the magnetic properties, it was difficult to discover a preferable range.

As seen when comparing Example 1 and Example 2-16, Examples 2-1 and 2-3, Examples 2-4 and 2-17, and Examples 2-8 and 2-12, when the compositions of the two soft magnetic layers are reversed, the SNR characteristic changes greatly (what had been superior (O) becomes unsatisfactory (x)). When the proportion of the (Fe₇₀Co₃₀) material responsible for the magnetic properties in the soft magnetic layer 2A on the nonmagnetic substrate side was greater than the proportion of the (Fe₇₀Co₃₀) material responsible for the magnetic properties in the soft magnetic layer 2C on the magnetic recording layer side, a magnetic recording medium which satisfied both requirements for the Squash characteristic and for SNR could be obtained.

From the results of Table 1, it is thought that a magnetic recording medium which satisfies requirements for both the Squash characteristic and for SNR has a proportion of the material (FeCo) responsible for the magnetic properties of the soft magnetic layer 2A on the nonmagnetic substrate side of 82.5 vol % or higher, and moreover has a proportion of the material (FeCo) responsible for the magnetic properties of the soft magnetic layer 2C on the magnetic recording layer side of less than 82.5 vol %. That is, when the material responsible for the magnetic properties is FeCo, the borderline proportion of the material (FeCo) responsible for the magnetic properties required for the soft magnetic layers 2A and 2C included in the soft magnetic underlayer in this invention is thought to be 82.5 vol % (Fe₇₀CO₃₀).

From the results of Table 2, in the soft magnetic layers comprising material responsible for the magnetic properties (FeCo) and the added materials B and Ta, there is a tradeoff between the relative permeability at 10 MHz and the characteristic frequency of relative permeability (the frequency at which the relative permeability has declined by 50% compared with the relative permeability at 10 MHz), and the higher the relative permeability of a soft magnetic layer, the more the characteristic frequency of relative permeability declines.

Viewed from the standpoint of the proportion of material (FeCo) responsible for the magnetic properties, the greater the amount of material (FeCo) responsible for the magnetic properties, the higher is the relative permeability at 10 MHz. In cases in which the proportion of material (FeCo) responsible for the magnetic properties is 82.5 vol % (Fe₇₀Co₃₀) or higher, the relative permeability is 700 or higher. Hence in conjunction with the result obtained from Table 1 for the borderline proportion of the material (FeCo) responsible for the magnetic properties of the soft magnetic layer 2A on the nonmagnetic substrate side and the soft magnetic layer 2C on the magnetic recording layer side, it is preferable that the soft magnetic layer 2A on the nonmagnetic substrate side have a higher permeability than the soft magnetic layer 2C on the magnetic recording layer side, and it is preferable that at least the relative permeability at 10 MHz of the soft magnetic layer 2A on the nonmagnetic substrate side be 700 or higher.

Further, the smaller the amount of material (FeCo) responsible for the magnetic properties, the higher is the characteristic frequency of relative permeability. In cases where the proportion of material (FeCo) responsible for the magnetic properties is 82 vol % (Fe₇₀Co₃₀) or lower, the characteristic frequency of relative permeability is 1000 MHz or higher. Hence in conjunction with the result obtained from Table 1 for the borderline proportion of the material (FeCo) responsible for the magnetic properties of the soft magnetic layer 2A on the nonmagnetic substrate side and the soft magnetic layer 2C on the magnetic recording layer side, it is preferable that the soft magnetic layer 2C on the magnetic recording layer side have a higher characteristic frequency of relative permeability than the soft magnetic layer 2A on the nonmagnetic substrate side, and that this value for the characteristic frequency of the relative permeability of the soft magnetic layer 2C on the magnetic recording layer side be 1000 MHz or higher.

As described above, from the results of Tables 1 and 2, in order to simultaneously satisfy requirements for the Squash characteristic and SNR characteristic, the soft magnetic layer on the magnetic recording layer side must have a higher characteristic frequency of relative permeability than the soft magnetic layer on the nonmagnetic substrate side. Further, it is necessary that the characteristic frequency of relative permeability of the soft magnetic layer on the magnetic recording layer side be 1000 MHz or higher, and that the relative permeability of either the soft magnetic layer on the nonmagnetic substrate side or of the soft magnetic layer on the magnetic recording layer side be 700 or higher.

Next, as is seen from the results for Examples 4-1 to 4-5 in Table 3, it is preferable that as the materials of the soft magnetic layers 2A and 2C of the magnetic recording medium of this invention, material (FeCo) responsible for the magnetic properties be combined with added material comprising an element among B, C, Ti, Zr, Hf, V, Nb and Ta, or a combination thereof. Among these combinations, when the proportion of the material (FeCo) responsible for the magnetic properties of the soft magnetic layer 2A on the nonmagnetic substrate side is higher than the proportion of the material (FeCo) responsible for the magnetic properties of the soft magnetic layer 2C on the magnetic recording layer side, a magnetic recording medium for which both the Squash characteristic and the SNR characteristic were superior could be obtained.

Further, from the examples of Tables 3 and 4 also, in order to simultaneously satisfy requirements for both the Squash characteristic and the SNR characteristic, the characteristic frequency of relative permeability of the soft magnetic layer on the magnetic recording layer side must be higher than that for the soft magnetic layer on the nonmagnetic substrate side. Further, it was necessary that the characteristic frequency of relative permeability of the soft magnetic layer on the magnetic recording layer side be 1000 MHz or higher, and that the relative permeability of either the soft magnetic layer on the nonmagnetic substrate side or of the soft magnetic layer on the magnetic recording layer side be 700 or higher.

As described above, by means of the configuration of the soft magnetic underlayer of this invention, a magnetic recording medium which can simultaneously satisfy requirements for the Squash characteristic and for the SNR characteristic could be obtained.

What is claimed is:

1. A magnetic recording medium for use on a nonmagnetic substrate, comprising:
a magnetic recording layer; and
a soft magnetic underlayer that has a stacked structure and that includes a soft magnetic layer on a nonmagnetic substrate side, an exchange coupling control layer, and a soft magnetic layer on a magnetic recording layer side, and
wherein the soft magnetic layer on the magnetic recording layer side has a higher relative permeability characteristic frequency (the frequency at which the relative permeability is reduced by 50% compared with the relative permeability at 10 MHz) than the soft magnetic layer on the nonmagnetic substrate side, and the soft magnetic layer on the nonmagnetic substrate side has a higher relative permeability than the soft magnetic layer on the magnetic recording layer side.

2. The magnetic recording medium according to claim 1, wherein, as a material responsible for magnetic properties in the soft magnetic underlayer, the soft magnetic layer on the nonmagnetic substrate side and the soft magnetic layer on the magnetic recording layer side include:
(i) a material including Fe and Co and responsible for the magnetic properties, and
(ii) an added material including an element selected from B, C, Ti, Zr, Hf, V, Nb or Ta, or a combination thereof.

3. The magnetic recording medium according to claim 2, wherein the characteristic frequency of the relative permeability of the soft magnetic layer on the magnetic recording layer side is 1000 MHz or higher, and the relative permeability of the soft magnetic layer on the nonmagnetic substrate side or of the soft magnetic layer on the magnetic recording layer side is 700 or higher.

4. A magnetic recording medium for use on a nonmagnetic substrate, comprising:
a magnetic recording layer; and
a soft magnetic underlayer that has a stacked structure and that includes a soft magnetic layer on a nonmagnetic substrate side, an exchange coupling control layer, and a soft magnetic layer on a magnetic recording layer side,
wherein the two soft magnetic layers are formed of a combination of soft magnetic layers including (i) a material including Fe and Co and responsible for the magnetic properties, and (ii) an added material including an element selected from B, C, Ti, Zr, Hf, V, Nb or Ta, or a combination thereof, and
wherein a proportion of the magnetic material including Fe and Co in the soft magnetic layer on the nonmagnetic substrate side is greater than a proportion of the magnetic material including Fe and Co in the soft magnetic layer on the magnetic recording layer side.

5. The magnetic recording medium according to claim 3, wherein, in the soft magnetic underlayer, the proportion of the magnetic material including Fe and Co in the soft magnetic layer on the nonmagnetic substrate side is 82.5 vol % or above, and the proportion of the magnetic material including Fe and Co in the soft magnetic layer on the magnetic recording layer side is less than 82.5 vol %.
